(19) United States
(12) Patent Application Publication
(10) Pub. No.: US 2013/0151483 A1
(43) Pub. Date: Jun. 13, 2013

(54) Adaptive experience based De-duplication

(71) Applicant: Jeffrey Tofano, San Jose, CA (US)

(72) Inventor: Jeffrey Tofano, San Jose, CA (US)

(73) Assignee: Quantum Corporation, San Jose, CA (US)

(21) Appl. No.: 13/373,990

(22) Filed: Dec. 7, 2011

(51) Int. Cl. G06F 7/00

(52) U.S. Cl. 707/692; 707/E17.002

(57) ABSTRACT

Example apparatus and methods associated with adaptive experience based de-duplication are provided. One example data de-duplication apparatus includes a de-duplication logic, an experience logic, and a reconfiguration logic. The de-duplication logic may be configured to perform data de-duplication according to a configurable approach that is a function of a pre-defined constraint. The experience logic may be configured to acquire de-duplication performance experience data. The reconfiguration logic may be configured to selectively reconfigure the configurable approach on the apparatus as a function of the de-duplication performance experience data. In different examples, dynamic reconfiguration may be performed locally and/or in a distributed manner based on local and/or distributed data that is acquired on a per actor (e.g., user, application) basis and/or on a per entity (e.g., computer, data stream) basis.

### BACKGROUND

De-duplication may involve dividing a larger piece of data into smaller pieces of data. De-duplication may be referred to as “dedupe”. Larger pieces of data may be referred to as “blocks” while the smaller pieces of data may be referred to as “sub-blocks” or “chunks”. Dividing blocks into sub-blocks may be referred to as “chunking”.

There are different approaches to chunking. In one approach, a rolling hash may identify sub-block boundaries in variable length chunking. In another approach, instead of identifying boundaries for variable sized chunks using a rolling hash, chunking may be performed by simply taking fixed size sub-blocks. In a hybrid approach, a combination of rolling hash variable length chunking may work together with fixed sized chunking.

Different chunking approaches may take different amounts of time to sub-divide a block into sub-blocks. Additionally, different chunking approaches may lead to more or less data reduction through dedupe. Therefore, chunking schemes have been characterized by performance (e.g., time), reduction (e.g., percent), and the balance between performance and reduction. By way of illustration, some chunking can be performed quickly but leads to less reduction while other chunking takes more time but leads to more reduction. For example, a variable sized chunking approach that considers multiple possible boundaries per chunk may take more time to perform but may yield substantial reduction. In contrast, a fixed size chunking approach that considers only a single fixed size sub-block may take less time to perform but may yield minimal, if any, reduction. So, there may be a tradeoff between performance time and data reduction.

Once a sub-block has been created, there are different dedupe approaches for determining whether the sub-block is a duplicate sub-block, whether the sub-block can be represented using a delta representation, whether the sub-block is a unique sub-block, and so on. One approach for determining whether a sub-block is unique involves hashing the sub-block and comparing the hash to hashes associated with previously encountered and/or stored sub-blocks. Different hashes may yield more or less unique determinations due, for example, to a collision rate associated with the hash. Another approach for determining whether a sub-block is unique involves sampling the sub-block and making a probabilistic determination based on the sampled data. For example, if none of the sample points match any stored sample points, then the sub-block may be unique while if a certain percentage of sample points match stored sample points then the sub-block may be a duplicate. Different sampling schemes may yield more or less unique determinations. Since different hashing and sampling schemes may yield more or less unique determinations, the different hashing and sampling approaches may also have different performance levels and may yield different amounts of data reduction.

Conventionally, different chunking, hashing, and/or sampling approaches may balance the tradeoff between performance and reduction in different ways. Aware of the different performance times and resulting data reductions, some dedupe schemes may first analyze the type of data to be deduped before deciding on an approach. These predictive schemes may decide, for example, that textual data should be deduped using a rolling hash boundary identification, variable length sub-block, hash based uniqueness determination dedupe approach while video data should be deduped using a fixed block sampling approach and music data should be deduped using a hybrid approach. Other predictive schemes may determine an approach based on the entropy of data to be processed. The different approaches may be based on a prediction of the resulting data reduction possible in a given period of time.

Chunking, hashing, and/or sampling may be controlled by a pre-defined constraint(s). Different pre-defined constraints may also yield different performance times and data reductions. Once again, predictive schemes may decide that different pre-defined constraints should be applied for different types of data.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a method associated with adaptive experience based de-duplication.

FIG. 2 illustrates additional detail for a method associated with adaptive experience based de-duplication.

FIG. 3 illustrates an apparatus associated with adaptive experience based de-duplication.

FIG. 4 illustrates an apparatus associated with adaptive experience based de-duplication.

FIG. 5 illustrates an example method associated with adaptive experience based de-duplication.

### DETAILED DESCRIPTION

Example apparatus and methods perform adaptive experience based chunking, hashing, and/or sampling. Example apparatus and methods also may perform adaptive experienced based uniqueness determinations. Thus, example apparatus and methods may perform adaptive experience based de-duplication. Example experience based approaches may track and/or access performance and data reduction for different chunking, hashing, and/or sampling approaches for different data types, users, computers, applications, and other entities. Similarly, example experience based approaches may track and/or access performance and data reduction for different uniqueness determination approaches for different data types, users, computers, applications, and other entities. Over time, different tradeoffs between performance and reduction may be identified for different approaches for different types of data that are chunked, hashed, and/or sampled in different ways. Over time, different tradeoffs between performance and reduction may also be identified for different approaches to making uniqueness determinations. As different tradeoffs are identified, selections for chunking, hashing, and other de-duplication decisions can be changed to yield desired performance times and desired reductions. It may be desirable to balance the tradeoff between performance and reduction in different ways under different conditions. For example, when data is being deduped in-line, then performance may trump reduction. However, when data is being deduped for deep storage, then reduction may trump performance.

Example apparatus and methods facilitate identifying chunking, hashing, sampling, and/or uniqueness determination approaches that achieve desired results for different types of data for different conditions (e.g., inline, deep, collaborative). As performance and reduction data is acquired, example systems and methods may automatically reconfigure themselves to more frequently perform dedupe using “superior” approaches and to less frequently perform dedupe using “inferior” approaches. Superiority and inferiority may have different definitions at different points in time from different points of view.

A dedupe environment may include many actors and entities. For example, an enterprise wide dedupe environment may include participants that work on different types of data in different locations. The enterprise wide dedupe environment may also include different machines that have different processing power and different communication capacity. Further complicating matters, some data may need to be very secure and may need to be backed up frequently while other data may be transient and may not need to be secure or backed up at all. The combination of data types, processing power, communication power, security, and backup requirements may produce different dedupe requirements at different locations. Therefore, it may be desirable to balance the performance/reduction tradeoff one way in one location and another way in another location.

In one example, a first dedupe apparatus or method may be configured to chunk, sample, and/or make uniqueness determinations in a first way. A second dedupe apparatus or method may be configured to chunk, sample, and/or make uniqueness determinations in a second way. Over time, the performance and reduction results being achieved by the first depdupe apparatus or method can be compared to the performance and reduction results being achieved by the second dedupe apparatus or method. The results may be evaluated in light of a desired balance between performance and reduction. The results may also be evaluated in light of different actors and/or entities. Then, based on actual historical data, rather than based on a prediction, one of the two approaches can be selected and both dedupe apparatus or methods can be controlled to perform dedupe using the selected approach. While two apparatus or methods are described, one skilled in the art will appreciate that more generally, N different approaches (N being an integer) could be evaluated and one or more approaches could be selected and either all or a subset of the apparatus or methods performing dedupe could be controlled to perform the one or more selected approaches.

In different examples, performance and reduction results can be analyzed locally and/or globally. Locally, an individual approach may chunk X bytes in Y seconds and achieve Z % reduction. Remotely, another individual approach may chunk X′ bytes in Y′ seconds and achieve Z′% reduction. Throughout an enterprise, other dedupe approaches may report their chunking and reduction results. In one example, based on requirements that an enterprise wants to achieve, either locally and/or globally, the local and/or global dedupe approach can be adapted based on the actual data. In one example, the approach may be changed substantially instantaneously and all members of a dedupe environment controlled to change at the same time. In another example, the approach may be changed more gradually with a subset of members of the dedupe environment being controlled to change over time.

Since dedupe may be performed for different actors (e.g., people, applications) and for different entities (e.g., data streams, computers), in one example, apparatus and methods are configured to track de-duplication experience data at the actor level and/or at the entity level. For example, one person, regardless of whether they are working in the Cleveland office this week or in the San Jose office next week may consistently process a certain type of data that achieves a desired balance of performance time versus reduction amount when a first approach is taken. Similarly, one type of application, whether it is run from Human Resources or from Engineering may consistently process a certain type of data that achieves a desired balance of performance time versus reduction amount when a second approach is taken. Thus, in one example, apparatus and methods may track performance and reduction data at the actor level to facilitate adapting at the actor level, rather than simply at the source or machine level.

This type of actor-level tracking and adaptation may produce a local optimization. Since the optimization may be local, this may lead to one part of an enterprise performing dedupe using a first approach and a second part of an enterprise performing dedupe using a second approach. Or, since the approach is local to the actor or entity, this may lead to a single machine performing dedupe a first way for a first actor and performing dedupe a second way for a second actor. This may in turn lead to an issue concerning reconciling deduped data or being able to use data deduped using the first approach for the second actor.

Therefore, in one example, apparatus and methods may be configured to identify how blocks were processed and to process information associated with reconstituting de-duplicated data. Additionally, in one example, apparatus and methods may be configured to store information concerning the approach used for a sub-block and/or for an actor. In one example, identification data may be provided in metadata that is associated with items included, but not limited to, a stream, a file, an actor, a block, and a sub-block. For example, a stream may be self-aware to the point that it knows that different dedupe approaches will yield different performance and reduction. Thus, in one example, a stream may be pre-pended with information about dedupe approaches and results previously achieved for the stream. By way of illustration, a set of files may be deduped a first time using a first approach and the performance and reduction tracked. This may occur, for example, during a first regular weekly backup. If the approach was adequate, then the set of files may be annotated with information about the approach that yielded the acceptable results. Then, during the next weekly backup, a dedupe apparatus or method may be provided with pre-defined constraints including, for example, chunking approach, sampling approach, hashing approach, and duplicate determination approach. Thus, the dedupe apparatus or method may be controlled to use the provided approach rather than using its own default approach.

In one example, apparatus and methods may be configured to associate data identifying a dedupe approach with blocks, sub-blocks, data streams, files, and so on. In one example, the information may be added to the block, sub-block, or so on. In another example, information about a dedupe approach may be added to an existing dedupe data structure (e.g., index). In yet another example, information about a dedupe approach may be stored in a separate dedupe data structure. One skilled in the art will appreciate that there are different ways to associate dedupe approach information with data to be deduped and/or with data that has been deduped.

Recall that example apparatus and methods can adapt dedupe approaches based on de-duplication experience data. Thus, a first dedupe apparatus or method may dedupe a first item (e.g., file) at a first time using a first approach. However, if the first dedupe apparatus or method is reconfigured based on de-duplication experience data, then the same first item may be deduped using a second approach at a second time. While the second approach may be used, the first approach does not have to be completely discarded or forgotten. Information concerning previous approaches can be maintained to facilitate recreating data that was deduped a first way even though the apparatus or method tasked with recreating the item is now performing dedupe a second way.

In one example, pre-defined constraints associated with dedupe may be under the control of the dedupe apparatus or method. In another example, the dedupe apparatus or method may accept the pre-defined constraint from an external source. If there are different pre-defined constraints available, then there may be different results for performance time and data reduction associated with the different pre-defined constraints. Therefore, example apparatus and methods may acquire de-duplication experience data for different pre-defined constraints and may adapt based on that de-duplication experience data.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

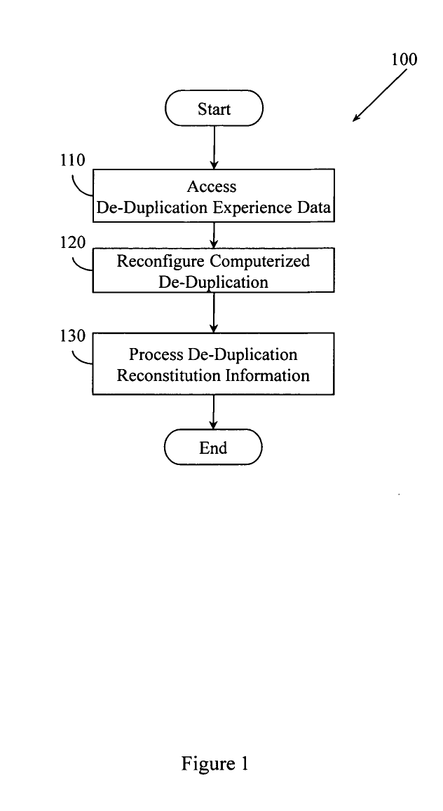

FIG. 1 illustrates a method 100 associated with adaptive experience based de-duplication. Method 100 includes, at 110, accessing de-duplication experience data, and, at 120, selectively automatically and dynamically reconfiguring computerized de-duplication as a function of the de-duplication experience data.

In one example, the de-duplication experience data may include, but is not limited to including, performance time data, and data reduction data. Performance time data may describe how long it takes to perform data reduction. Data reduction data may describe a data reduction factor. For example, if a data set occupies 1 Mb of storage before de-duplication but consumes 500 Kb of storage after de-duplication, then the data reduction factor would be 50%.

In different examples, the computerized de-duplication may be reconfigured at 120 based on data including, but not limited to, local de-duplication experience data, and distributed de-duplication experience data. Since both local and distributed data may be available, in different examples the reconfiguring at 120 may include reconfiguring a local apparatus or a remote apparatus.

Method 100 may also include, at 130, processing de-duplication reconstitution information for an item that has been de-duplicated using a reconfigured computerized de-duplication. The de-duplication reconstitution information can identify items including, but not limited to, the computerized de-duplication employed to de-duplicate the item, and the de-duplication experience data employed to reconfigure the computerized de-duplication.

In one example, processing the de-duplication reconstitution information at 130 may include adding de-duplication reconstitution information to a de-duplication data structure. The data structure may be, for example, a chunk store, an index, or another data structure. Adding the information may include adding a new record to a data structure, appending information to an existing record in a data structure, and so on. The information may identify items including, but not limited to, the computerized de-duplication employed to de-duplicate the item, and the de-duplication experience data employed to reconfigure the computerized de-duplication.

In another example, processing the de-duplication reconstitution information at 130 may include associating de-duplication reconstitution information with a data source. In this example, the de-duplication reconstitution information may identify items including, but not limited to, the computerized de-duplication approach employed to deduplicate data from the data source, and the de-duplication experience data employed to reconfigure the computerized de-duplication for the data source.

In yet another example, processing the de-duplication reconstitution information at 130 may include adding de-duplication reconstitution information to the item that has been de-duplicated using a reconfigured computerized de-duplication. The information may be added, for example, as metadata, as a header, as a footer, and so on.

In one example, dynamically reconfiguring computerized de-duplication at 120 may be performed on a per actor basis, a per entity basis, and or a combination of both. Thus, in different examples, de-duplication may be reconfigured for a user, for a computer, for a data source, for a location, for an application, and so on.

While FIG. 1 illustrates various actions occurring in serial, it is to be appreciated that various actions illustrated in FIG. 1 could occur substantially in parallel. By way of illustration, a first process could access de-duplication experience data, a second process could reconfigure computerized de-duplication, and a third process could process de-duplication reconstitution information. While three processes are described, it is to be appreciated that a greater and/or lesser number of processes could be employed and that lightweight processes, regular processes, threads, and other approaches could be employed.

In one example, a method may be implemented as computer executable instructions. Thus, in one example, a computer-readable medium may store computer executable instructions that if executed by a machine (e.g., processor) cause the machine to perform a method that includes acquiring de-duplication experience data comprising performance time data and reduction amount data. The performance experience data may be acquired on a per actor basis, a per entity basis, or a combination thereof and the performance experience data may be acquired on a local basis, a distributed basis, or a combination thereof. The method may also include selectively automatically and dynamically changing items including a boundary placing approach, a chunking approach, a hashing approach, a sampling approach, and a uniqueness determination approach for a computerized de-duplication apparatus. The changes may be made as a function of the de-duplication experience data. In one example, the reconfiguring may include reconfiguring local computerized de-duplication based on local de-duplication experience data and reconfiguring distributed computerized de-duplication based on distributed de-duplication experience data. Additionally, the reconfiguring may include reconfiguring on a per actor basis, and reconfiguring on a per entity basis.

While executable instructions associated with the above method are described as being stored on a computer-readable medium, it is to be appreciated that executable instructions associated with other example methods described herein may also be stored on a computer-readable medium.

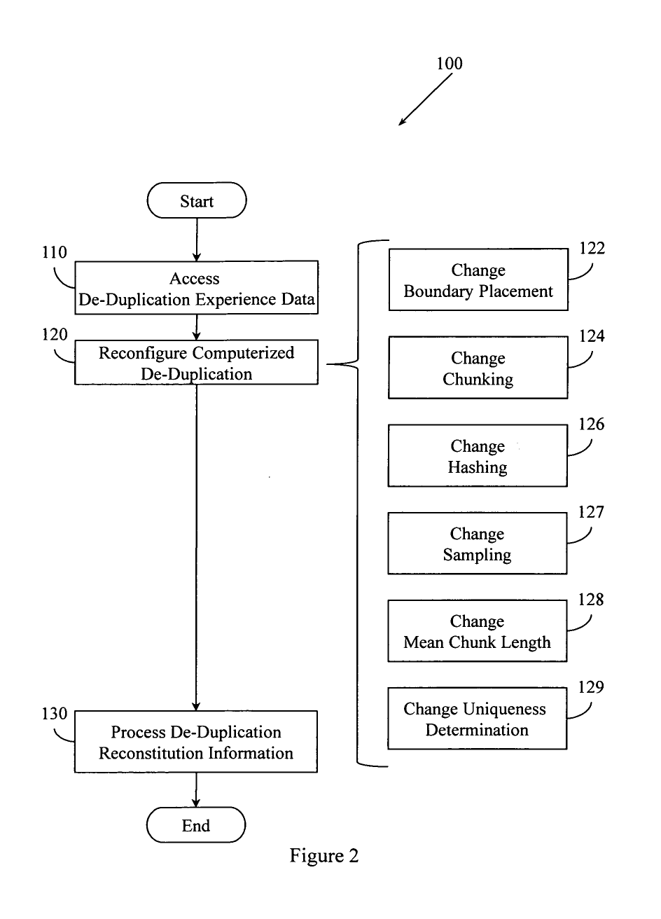

FIG. 2 illustrates additional detail for one embodiment of method 100. In this embodiment, reconfiguring computerized de-duplication at 120 can include several actions. The actions can include, but are not limited to, changing a boundary placing approach at 122, changing a chunking approach at 124, changing a hashing approach at 126, changing a sampling approach at 127, changing a desired mean chunk length at 128, and changing a uniqueness determination approach at 129. In different examples, reconfiguring computerized de-duplication at 120 can include one, two, or more of the example changes.

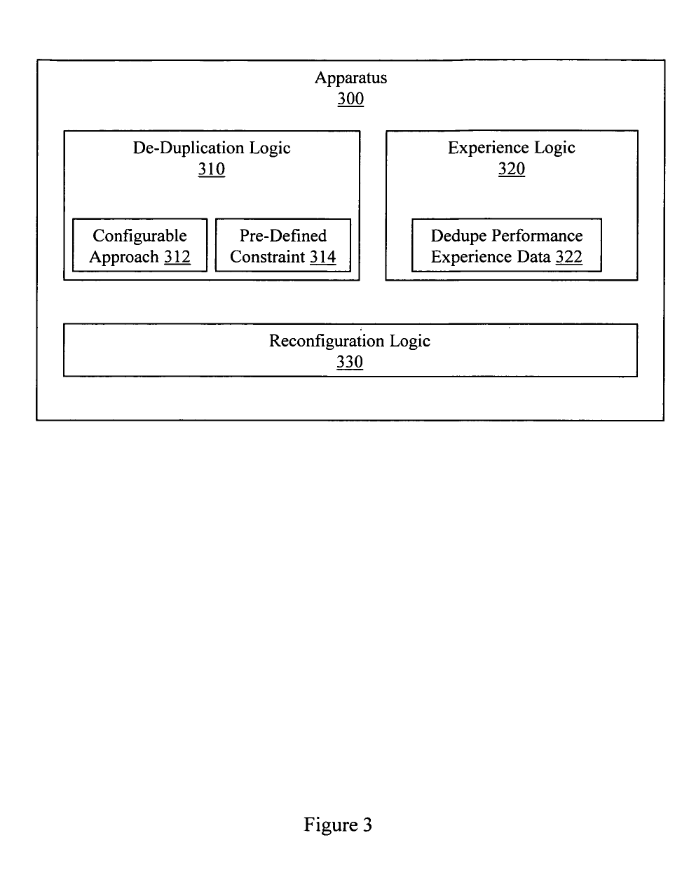

FIG. 3 illustrates an apparatus 300 associated with adaptive experience based de-duplication. Apparatus 300 includes a de-duplication logic 310, an experience logic 320, and a reconfiguration logic 330. Apparatus 300 may also include a processor, a memory, and an interface configured to connect the processor, the memory, and the logics.

The de-duplication logic 310 may be configured to perform data de-duplication according to a configurable approach 312 that is a function of a pre-defined constraint 314. The pre-defined constraint 314 may define, for example, a hashing approach, a sampling approach, a uniqueness determination approach, and so on. In different embodiments, the configurable approach 312 may be configurable on attributes including, but not limited to, boundary placement approach, chunking approach, desired mean chunk length, sampling locations, sampling size, uniqueness determination approach, and hashing approach.

The experience logic 320 may be configured to acquire de-duplication performance experience data 322. In one example, the experience logic 320 is configured to acquire the de-duplication performance experience data 322 on a per user basis, a per entity basis, or a combination of both. In different embodiments, the de-duplication performance experience data 322 may include, but is not limited to including, data reduction amount data, and data reduction time data. In different embodiments, the de-duplication performance experience data 322 may include data from the data de-duplication apparatus 300 and data from a second, different data de-duplication apparatus.

The reconfiguration logic 330 may be configured to selectively reconfigure the configurable approach 312 on the apparatus 300 as a function of the de-duplication performance experience data 322. For example, when the de-duplication performance experience data indicates that a superior approach may be available, then the configurable approach 312 may be reconfigured. In another example, when the de-duplication performance experience data 322 indicates that a desired data reduction time is not being achieved, then the configurable approach 312 may be changed in an attempt to speed up processing. In another example, when the de-duplication performance experience data 322 indicates that a desired data reduction factor is not being achieved, then the configurable approach 312 may also be changed in an attempt to achieve greater reduction. In another example, the de-duplication performance experience data 322 may indicate that certain types of data are being de-duplicated in an acceptable manner while other types of data are not being acceptably de-duplicated. In this example, the configurable approach 312 may be changed in an attempt to have more data types de-duplicated in an acceptable manner.

The reconfiguration logic 330 may be configured to selectively reconfigure the de-duplication approach 312 on a per user basis, on a per entity basis, or on a combination thereof. Thus, de-duplication performance experience data 322 for one user may be used to inform a decision to change the de-duplication approach 312 for a different user or users. Similarly, de-duplication performance experience data 322 for one data source may be used to inform a decision to change the de-duplication approach 312 for a different data source.

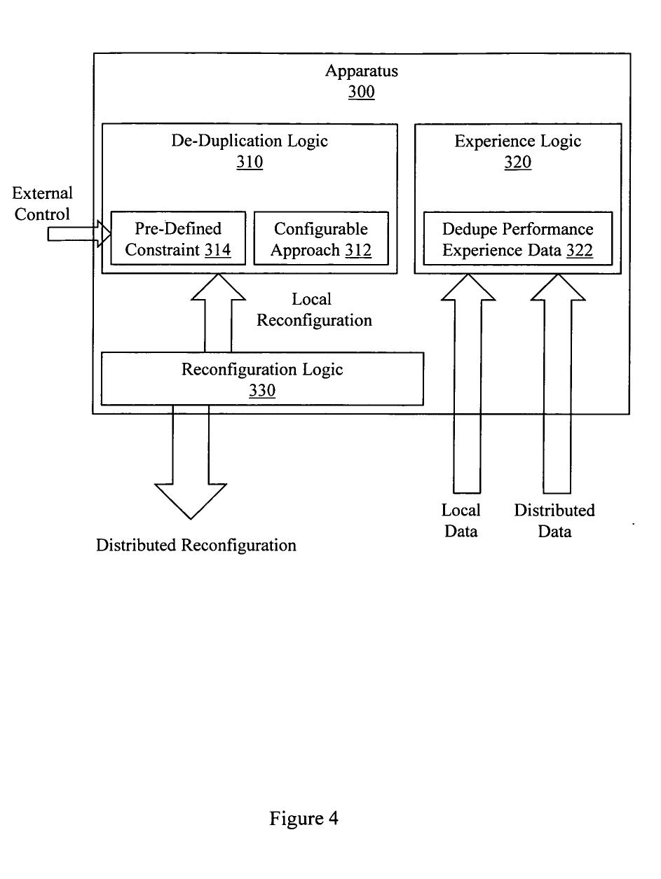

FIG. 4 illustrates another embodiment of apparatus 300. In this embodiment, the pre-defined constraint 314 may be controlled by either the data de-duplication apparatus 300 or may experience external control. The external control may be exercised, for example, by another de-duplication apparatus, a control server, a timer, and other items. In this embodiment of apparatus 300, the reconfiguration logic 330 may be configured to perform local reconfiguration by selectively reconfiguring the configurable approach 312 on apparatus 300 and to perform distributed reconfiguration by selectively reconfiguring a configurable approach for one or more second data de-duplication apparatus as a function of the de-duplication performance experience data 322. In this embodiment, the de-duplication performance data 322 may include local data and/or distribute data.

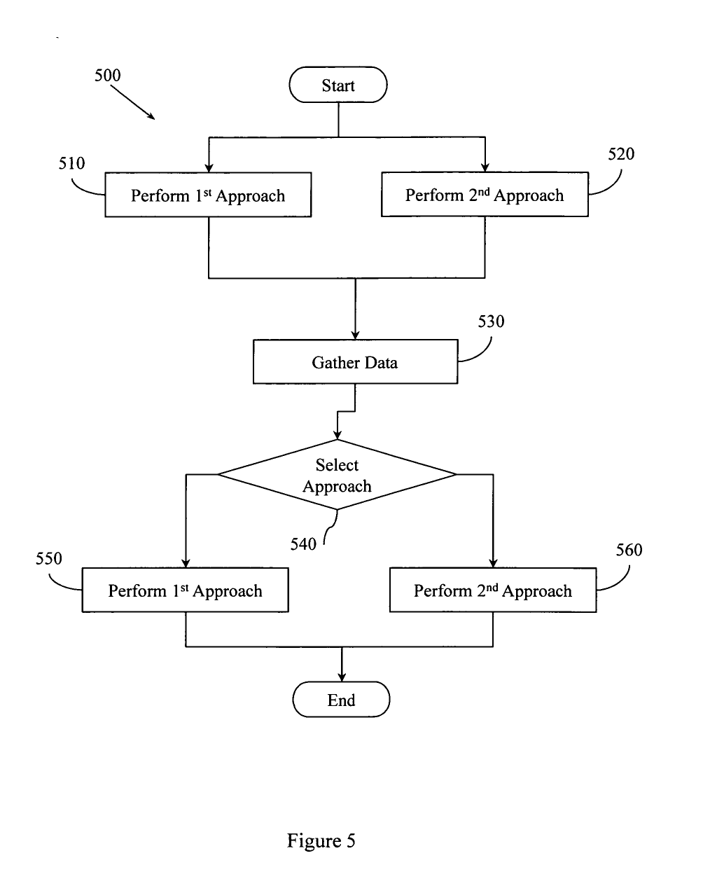

FIG. 5 illustrates a method 500 associated with adaptive experience based de-duplication. Method 500 illustrates two de-duplications being performed in parallel. A first approach is performed at 510 and a second approach is performed at 520. Data about the two different approaches is gathered at 530. After an amount of data suitable for making a decision has been acquired, a decision may be made at 540 concerning which of the two approaches is to be continued. If the decision is for approach 510, then processing may continue at 550 while if the decision is for approach 520, the processing may continue at 560. While two approaches are illustrated at 510 and 520, and while two corresponding approaches are illustrated at 550 and 560, one skilled in the art will appreciate that data may be acquired for more than two approaches and that different, perhaps non-corresponding approaches may be selected based on the gathered data. For example, five “test” approaches may be allowed to run for a period of time. These test approaches may provide information upon which “run” approaches may be selected. The “run” approaches may not need to be exact mimics of the “test” approaches but may be selected based on information acquired by running the test approaches.

In one example, the two or more reconfigurable computerized de-duplication approaches may be run in parallel, may be interleaved, or may be combined in other ways.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, refers to a medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

While example apparatus, methods, and computer-readable media have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A method, comprising:
accessing de-duplication experience data; and
selectively automatically and dynamically reconfiguring computerized de-duplication as a function of the de-duplication experience data.

2. The method of claim 1, where the de-duplication experience data comprises one or more of, performance time data, and data reduction data.

3. The method of claim 2, where reconfiguring computerized de-duplication comprises changing one or more of, a boundary placing approach, a chunking approach, a hashing approach, a sampling approach, a desired mean chunk length, and a uniqueness determination approach.

4. The method of claim 1, comprising reconfiguring local computerized de-duplication based on local de-duplication experience data.

5. The method of claim 1, comprising reconfiguring distributed computerized de-duplication based on distributed de-duplication experience data.

6. The method of claim 1, comprising processing de-duplication reconstitution information for an item that has been de-duplicated using a reconfigured computerized de-duplication, where the de-duplication reconstitution information identifies one or more of, the computerized de-duplication employed to de-duplicate the item, and the de-duplication experience data employed to reconfigure the computerized de-duplication.

7. The method of claim 6, where processing the de-duplication reconstitution information comprises adding de-duplication reconstitution information to a de-duplication data structure, where the information identifies one or more of, the computerized de-duplication employed to de-duplicate the item, and the de-duplication experience data employed to reconfigure the computerized de-duplication.

8. The method of claim 6, where processing the de-duplication reconstitution information comprises associating de-duplication reconstitution information with a data source, where the de-duplication reconstitution information identifies one or more of, the computerized de-duplication approach employed to de-duplicate data from the data source, and the de-duplication experience data employed to reconfigure the computerized de-duplication for the data source.

9. The method of claim 6, where processing the de-duplication reconstitution information comprises adding de-duplication reconstitution information to the item that has been de-duplicated using a reconfigured computerized de-duplication.

10. The method of claim 1, comprising:
performing two or more reconfigurable computerized de-duplication approaches in parallel;
acquiring performance experience data for the two or more reconfigurable approaches; and
selectively automatically and dynamically reconfiguring the computerized de-duplication to perform one of the two or more reconfigurable computerized de-duplication approaches based on the performance experience data for the two or more reconfigurable approaches.

11. The method of claim 1, comprising dynamically reconfiguring computerized de-duplication as a function of de-duplication experience data on one or more of, a per actor basis, and a per entity basis.

12. A data de-duplication apparatus, comprising:
a processor;
a memory;
a set of logics; and
an interface configured to connect the processor, the memory, and the set of logics,
the set of logics comprising:
a de-duplication logic configured to perform data de-duplication according to a configurable approach, where the configurable approach is a function of a pre-defined constraint;
an experience logic configured to acquire de-duplication performance experience data; and
a reconfiguration logic configured to selectively reconfigure the configurable approach on the apparatus as a function of the de-duplication performance experience data.

13. The apparatus of claim 12, where the de-duplication performance experience data comprises one or more of, data reduction amount data, and data reduction time data.

14. The apparatus of claim 13, where the de-duplication performance experience data comprises one or more of, data from the data de-duplication apparatus, and data from a second, different data de-duplication apparatus.

15. The apparatus of claim 12, where the configurable approach is configurable on one or more of, boundary placement approach, chunking approach, desired mean chunk length, sampling locations, sampling size, uniqueness determination approach, and hashing approach.

16. The apparatus of claim 12, where the reconfiguration logic is configured to selectively reconfigure the configurable approach on a second data de-duplication apparatus as a function of the de-duplication performance experience data.

17. The apparatus of claim 12, where the pre-defined constraint is controlled by the data de-duplication apparatus.

18. The apparatus of claim 12, where the pre-defined constraint is controlled by an entity external to the apparatus.

19. The apparatus of claim 12, where the experience logic is configured to acquire the de-duplication performance experience data on one or more of, a per user basis, and a per entity basis.

20. The apparatus of claim 19, where the reconfiguration logic is configured to selectively reconfigure the configurable approach on one or more of, a per user basis, and a per entity basis.

21. A computer-readable medium storing computer-executable instructions that when executed by a data de-duplication apparatus control the data de-duplication apparatus to perform a method, the method comprising:
acquiring de-duplication experience data comprising performance time data and reduction amount data, where the performance experience data is acquired on one or more of, a per actor basis, and a per entity basis, and where the performance experience data is acquired on one or more of, a local basis, and a distributed basis,
and;
selectively automatically and dynamically changing one or more of, a boundary placing approach, a chunking approach, a hashing approach, a sampling approach, and a uniqueness determination approach for a computerized de-duplication apparatus as a function of the de-duplication experience data,
where the reconfiguring comprises one or more of, reconfiguring local computerized de-duplication based on local de-duplication experience data and reconfiguring distributed computerized de-duplication based on distributed de-duplication experience data, and
where the reconfiguring comprises one or more of, reconfiguring on a per actor basis, and reconfiguring on a per entity basis.

22. A system, comprising:
means for dynamically reconfiguring a computerized de-duplication apparatus based on one or more of, de-duplication time data, and de-duplication reduction data.
